(19) United States
(12) Patent Application Publication
(10) Pub. No.: US 2023/0079116 A1
(43) Pub. Date: Mar. 16, 2023

(54) ADAPTIVE COMMUNICATION FOR A VEHICLE IN A COMMUNICATION NETWORK

(71) Applicant: GM GLOBAL TECHNOLOGY OPERATIONS LLC, DETROIT, MI (US)

(72) Inventor: Jimmy Qi, Shanghai (CN)

(21) Appl. No.: 17/473,069

(22) Filed: Sep. 13, 2021

(51) Int. Cl. B60W 60/00; B60W 40/072; B60W 40/04; H04W 4/44; H04W 4/46; G06N 3/02

(52) U.S. Cl. CPC B60W 60/00184; B60W 40/072; B60W 40/04; H04W 4/44; H04W 4/46; G06N 3/02; B60W 2552/30; B60W 2552/53; B60W 2556/65

(57) ABSTRACT

A method of controlling operation of a vehicle includes monitoring one or more features of a road segment, the vehicle configured to communicate with a plurality of objects in a wireless communication network, the vehicle configured to generate a communication based on a reference value of a parameter related to at least one of an environment around the vehicle and a behavior of the vehicle. The method also includes determining, based on the monitoring, a condition of the road segment, the condition including at least a curvature of the road segment, inputting the condition into a machine learning model configured to adjust the reference value based on the condition and output an adjusted reference value, and comparing the adjusted reference value to a current parameter value, and based on the adjusted reference value matching the current parameter value, transmitting an alert to one or more of the plurality of objects.

### INTRODUCTION

The subject disclosure relates to vehicles, and more particularly to communication between vehicles and objects via a communication network.

Many vehicles (e.g., cars, motorcycles, boats, or any other types of automobile) are equipped with a vehicular communication system that facilitates different types of communication between the vehicle and other entities. For example, some vehicles are equipped with communication systems that enable vehicle-to-vehicle (V2V) or vehicle-to-everything (V2X) communications to send and/or receive safety messages, maintenance messages, vehicle status messages, and the like. For example, a vehicle equipped with V2X capability can generate an alert or safety message in response to detecting various conditions (e.g., a vehicle can alert other vehicles of an accident, roadwork or other condition that could affect vehicle operation). In some situations, existing communication systems may not be able to detect potential adverse conditions.

Accordingly, it is desirable to provide a system that can enhance vehicle communication, for example, to increase safety, enhance performance and/or increase drivability.

### SUMMARY

In one exemplary embodiment, a method of controlling operation of a vehicle includes monitoring one or more features of a road segment, the vehicle configured to communicate with a plurality of objects in a wireless communication network, the vehicle configured to generate a communication based on a reference value of a parameter related to at least one of an environment around the vehicle and a behavior of the vehicle. The method also includes determining, based on the monitoring, a condition of the road segment, the condition including at least a curvature of the road segment, inputting the condition into a machine learning model, the machine learning model configured to adjust the reference value of the parameter based on the condition and output an adjusted reference value, and comparing the adjusted reference value to a current parameter value, and based on the adjusted reference value matching the current parameter value, transmitting an alert to one or more of the plurality of objects.

In addition to one or more of the features described herein, the condition includes a variation in width of at least one of the road segment and a road lane.

In addition to one or more of the features described herein, the machine learning model includes a neural network.

In addition to one or more of the features described herein, determining the condition includes acquiring sensor data from at least one other vehicle ahead of the vehicle.

In addition to one or more of the features described herein, determining the condition includes estimating the curvature based on the acquired sensor data.

In addition to one or more of the features described herein, the condition includes an estimation of traffic flow based at least on the acquired sensor data.

In addition to one or more of the features described herein, the wireless communication network is at least one of a vehicle-to-vehicle (V2V) and a vehicle-to-everything (V2X) network.

In addition to one or more of the features described herein, the reference value of the parameter is a predetermined reference value selected based on a communication protocol of the wireless communication network.

In one exemplary embodiment, system for controlling operation of a vehicle includes a monitoring unit configured to monitor one or more features of a road segment. The vehicle is configured to communicate with a plurality of objects in a wireless communication network, the vehicle is configured to generate a communication based on a reference value of a parameter related to at least one of an environment around the vehicle and a behavior of the vehicle, and the monitoring unit configured to determine, based on the monitoring, a condition of the road segment, the condition including at least a curvature of the road segment. The system also includes an adjustment unit configured to input the condition to a machine learning model, the machine learning model configured to adjust the reference value of the parameter based on the condition and output an adjusted reference value, and a processing unit configured to compare the adjusted reference value to a current parameter value, and based on the adjusted reference value matching the current parameter value, transmit an alert to one or more of the plurality of objects.

In addition to one or more of the features described herein, the condition includes a variation in width of at least one of the road segment and a road lane.

In addition to one or more of the features described herein, the machine learning model includes a neural network.

In addition to one or more of the features described herein, determining the condition includes acquiring sensor data from at least one other vehicle ahead of the vehicle.

In addition to one or more of the features described herein, determining the condition includes estimating the curvature based on the acquired sensor data.

In addition to one or more of the features described herein, the condition includes an estimation of traffic flow based at least on the acquired sensor data.

In addition to one or more of the features described herein, the wireless communication network is at least one of a vehicle-to-vehicle (V2V) and a vehicle-to-everything (V2X) network.

In addition to one or more of the features described herein, the reference value of the parameter is a predetermined reference value selected based on a communication protocol of the wireless communication network.

In one exemplary embodiment, a vehicle system includes a memory having computer readable instructions, and a processing device for executing the computer readable instructions, the computer readable instructions controlling the processing device to perform a method. The method includes monitoring one or more features of a road segment, the vehicle configured to communicate with a plurality of objects in a wireless communication network, the vehicle configured to generate a communication based on a reference value of a parameter related to at least one of an environment around the vehicle and a behavior of the vehicle. The method also includes determining, based on the monitoring, a condition of the road segment, the condition including at least a curvature of the road segment, inputting the condition into a machine learning model, the machine learning model configured to adjust the reference value of the parameter based on the condition and output an adjusted reference value, comparing the adjusted reference value to a current parameter value, and based on the adjusted reference value matching the current parameter value, transmitting an alert to one or more of the plurality of objects.

In addition to one or more of the features described herein, the condition includes a variation in width of at least one of the road segment and a road lane.

In addition to one or more of the features described herein, the machine learning model includes a neural network.

In addition to one or more of the features described herein, the wireless communication network is at least one of a vehicle-to-vehicle (V2V) and a vehicle-to-everything (V2X) network, and the reference value of the parameter is a predetermined reference value selected based on a communication protocol of the wireless communication network.

The above features and advantages, and other features and advantages of the disclosure are readily apparent from the following detailed description when taken in connection with the accompanying drawings.

### BRIEF DESCRIPTION OF THE DRAWINGS

Other features, advantages and details appear, by way of example only, in the following detailed description, the detailed description referring to the drawings in which:

FIG. 1 is a top view of a motor vehicle including various processing devices, in accordance with an exemplary embodiment;

FIG. 2 depicts a computer system, in accordance with an exemplary embodiment;

FIG. 3 is a flow diagram depicting aspects of a method of monitoring an environment around a vehicle and communicating with objects in a communication network based on a detected or estimated condition, in accordance with an exemplary embodiment;

FIG. 4 is a flow diagram depicting aspects of a method of training a machine learning or artificial intelligence model, in accordance with an exemplary embodiment;

FIG. 5 is a flow diagram depicting aspects of a method of monitoring an environment around a vehicle and communicating with objects in a communication network, and/or training a machine learning or artificial intelligence model, in accordance with an exemplary embodiment; and

FIG. 6 depicts an example of an environment including a road segment and conditions of the environment, and illustrates an example of performing aspects of the method of FIG. 5.

### DETAILED DESCRIPTION

The following description is merely exemplary in nature and is not intended to limit the present disclosure, its application or uses. It should be understood that throughout the drawings, corresponding reference numerals indicate like or corresponding parts and features.

Devices, systems and methods are provided for communication between objects of a communication network and/or automated or semi-automated vehicle control. An embodiment of a method of vehicle control (e.g., causing the vehicle to present or transmit an alert and/or controlling vehicle behavior) includes acquiring sensor data from one or more sensors in a vehicle (e.g., camera and/or radar data), estimating features of an environment (e.g., including a road segment or road length) around a vehicle, and determining a condition in the environment that could potentially prompt a communication, and/or an evasive maneuver or other vehicle behavior. In an embodiment, the condition includes a curvature of a road segment on which the vehicle is traveling or approaching, and may also include a width of the road segment (or lane) and/or a width variation. Road features such curvature and width may be determined by sensor data in an ego vehicle, or based on messages transmitted from other vehicles (e.g., a vehicle in front of the ego vehicle). It is noted that a “condition” is broadly defined as any combination of features in an environment (e.g., road features, other vehicles, pedestrians, etc.), situations arising in the environment, and vehicle behavior (e.g., speed and heading).

The method also includes inputting the condition to an artificial intelligence or machine learning model (e.g., a neural network), and generating an alert based on an output from the model. In an embodiment, the vehicle is part of a communication network and is configured to generate alerts based on predetermined criteria established by a communication protocol associated with the network. The predetermined criteria may be a pre-selected parameter value (e.g., vehicle speed, proximity to other vehicles, etc.) referred to as a reference parameter value. The model, in an embodiment, is configured to adjust the reference parameter value or output a different reference parameter value by which the vehicle determines whether to generate an alert. If an alert is generated, the alert may be in the form of a warning or other indication to a vehicle user (e.g., driver and/or passenger) and/or an alert message transmitted to other vehicles or objects in the communication network. The method may also include training the model based on training data.

In an embodiment, the vehicle is configured to communicate with other vehicles and/or objects as part of a vehicle-to-vehicle (V2V) and/or vehicle-to-everything (V2X) communication network. For example, the vehicle is equipped with a telematics module or other device or system for communicating with other vehicles and/or objects (e.g., roadside units) using, for example, short range wireless signals. In an embodiment, the model is trained to associate various scenarios or conditions with a reference parameter value that triggers an alert (an indication to a user and/or an alert message). For example, a machine learning model is trained with map data, previously collected data from other vehicles, and parameters used to trigger communications. Based on the training, the model is configured to estimate adjusted or optimized reference parameter values that are correlated to each of a variety of conditions and situations.

Embodiments described herein present numerous advantages and technical effects. The embodiments enhance current V2X and/or other communication systems by dynamically adapting or adjusting the criteria by which such systems generate alerts and/or prescribe evasive actions. For example, the embodiments provide for an adaptive V2X communication system that can effectively respond to road conditions and adaptively fit for different situations, provide precise warnings and enhance the driving experience.

For example, many V2X safety applications are not flexible enough for various scenarios, such as driving on a curved road and/or a road having a variable width, or driving on such a road in a low speed area and/or congested area. Predefined parameter values (reference parameter values) of V2X application may lead to false alarms and failure of warnings, thereby negatively affecting the driving experience. Embodiments described herein address such problems by providing an adaptive system and method that can dynamically adjust criteria for generating more accurate and relevant alerts.

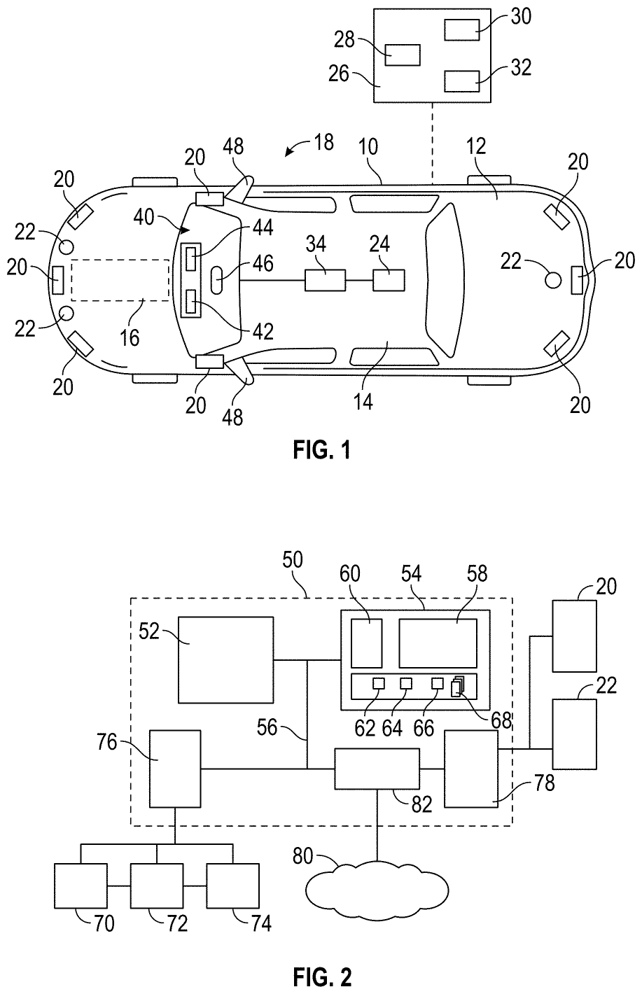

FIG. 1 shows an embodiment of a motor vehicle 10, which includes a vehicle body 12 defining, at least in part, an occupant compartment 14. The vehicle body 12 also supports various vehicle subsystems including an engine system 16 (e.g., combustion, electric or hybrid), and other subsystems to support functions of the engine system 16 and other vehicle components, such as a braking subsystem, a steering subsystem, a fuel injection subsystem, an exhaust subsystem and others.

The vehicle 10 also include a monitoring system 18 that includes various sensors for detecting objects, features and conditions in an environment around the vehicle 10. For example, the vehicle 10 includes one or more optical cameras 20 configured to take images such as color (RGB) images. Images may be still images or video images. One or more radar assemblies 22 may also be included in the vehicle 10 Other examples of sensors include lidar assemblies or systems.

An embodiment of the vehicle 10 includes devices and/or systems for communicating with other vehicles and/or objects external to the vehicle. For example, the vehicle 10 includes a communication system having a telematics unit 24 or other suitable device including an antenna or other transmitter/receiver for communicating with a network 26.

The network 26 represents any one or a combination of different types of suitable communications networks, such as public networks (e.g., the Internet), private networks, wireless networks, cellular networks, or any other suitable private and/or public networks. Further, the network 26 can have any suitable communication range associated therewith and may include, for example, global networks (e.g., the Internet), metropolitan area networks (MANs), wide area networks (WANs), local area networks (LANs), or personal area networks (PANs). The network 26 can communicate via any suitable communication modality, such as short range wireless, radio frequency, satellite communication, or any combination thereof.

In an embodiment, the network is configured as a communication network that allows various vehicles and/or objects (e.g., roadside units, servers, mobile devices, cellular towers, GPS units, etc.) to communicate with one another. Such communication may be for transmitting information (e.g. traffic conditions, road conditions, features in an environment, etc.) and/or alerts.

In an embodiment, the network 26 is a vehicle-to-vehicle (V2V) and/or vehicle-to-everything (V2X) network. The network 26 allows for communication between the vehicle 10 and various other vehicles and objects or entities, and provides a communication protocol that governs when and under what conditions an alert is to be provided. An object may be considered a node in the network, and may be any vehicle, device, processing unit, roadside unit or other entity that can communicate via the network.

The V2X network can encompass a variety of communications, such as vehicle-to-infrastructure (V2I), vehicle-to-vehicle (V2V), vehicle-to-pedestrian (V2P), and/or vehicle-to-grid (V2G) communication. Collectively, these may be referred to as V2X communication that enables communication of information from the vehicle 10 to any other suitable entity. A processing system of the vehicle 10 (or a processing system in communication with the vehicle 10, such as a mobile device) may be equipped with one or more of various software programs or applications (collectively referred to as a V2X application) that include protocols for V2X communications to send and/or receive safety messages, maintenance messages, vehicle status messages, and the like.

For example, the network 26 is configured as at least part of a V2X network that allows the telematics unit 24 to communicate with nodes in the form of other vehicles 28, roadside units 30 and/or devices 32 (e.g. servers, mobile devices, etc.).

The cameras 20 and/or radar assemblies 22, the telematics unit 24 and/or other processing devices (e.g., one or more vehicle control units 34) may communicate with one or more processing devices, such as an on-board processing system 40 including a processing device 42 and a user interface 44. The user interface 44 may include a touchscreen, a speech recognition system and/or various buttons for allowing a user to interact with features of the vehicle 10, and may be used to present an alert to a user. The user interface 44 may be configured to interact with the user via visual communications (e.g., text and/or graphical displays), tactile communications or alerts (e.g., vibration), and/or audible communications.

In addition to the user interface 44, the vehicle 10 may include other types of displays and/or other devices that can interact with and/or impart information to a user. For example, the vehicle 10 may include a display screen (e.g., a full display mirror or FDM) incorporated into a rearview mirror 46 and/or one or more side mirrors 48. In one embodiment, the vehicle 10 includes one or more heads up displays (HUDs). Other devices that may be incorporated include indicator lights, haptic devices, interior lights, auditory communication devices, and others. Any combination of the various interfaces and device may be used to present alerts to a user.

FIG. 2 illustrates aspects of an embodiment of a computer system 50 that is in communication with, or is part of, a vehicle system, and that can perform various aspects of embodiments described herein. The computer system 50 includes at least one processing device 52, which generally includes one or more processors for performing aspects of methods described herein. The processing device 52 can be integrated into the vehicle 10, for example, as the on-board processing device 42, or can be a processing device separate from the vehicle 10, such as a server, a personal computer or a mobile device (e.g., a smartphone or tablet). For example, the processing device 52 can be part of, or in communication with, one or more engine control units (ECU), one or more vehicle control modules, a cloud computing device, a vehicle satellite communication system, a network such as the V2X network and/or others. The processing device 52 may be configured to perform modeling, analysis and communication methods described herein, and may also perform functions related to control of various vehicle subsystems.

Components of the computer system 50 include the processing device 52 (such as one or more processors or processing units), a system memory 54, and a bus 56 that couples various system components including the system memory 54 to the processing device 52. The system memory 54 may include a variety of computer system readable media. Such media can be any available media that is accessible by the processing device 52, and includes both volatile and non-volatile media, removable and non-removable media.

For example, the system memory 54 includes a non-volatile memory 58 such as a hard drive, and may also include a volatile memory 60, such as random access memory (RAM) and/or cache memory. The computer system 50 can further include other removable/non-removable, volatile/non-volatile computer system storage media.

The system memory 54 can include at least one program product having a set (e.g., at least one) of program modules that are configured to carry out functions of the embodiments described herein. For example, the system memory 54 stores various program modules that generally carry out the functions and/or methodologies of embodiments described herein. A monitoring module (monitoring unit) 62 may be included to perform functions related to acquiring and processing sensor data and detecting various features in an environment. An adjustment module (adjustment unit) 64 may be included for training and maintaining models, and applying input data to models to control or adjust criteria for generating alerts and/or communications. A processing module (processing unit) such as a communication unit 66 may be provided for making alert and communication decisions based on the adjusted criteria.

The system memory 54 may also store various data structures 68, such as data files or other structures, and models for performing methods described herein. As used herein, the term “module” refers to processing circuitry that may include an application specific integrated circuit (ASIC), an electronic circuit, a processor (shared, dedicated, or group) and memory that executes one or more software or firmware programs, a combinational logic circuit, and/or other suitable components that provide the described functionality.

The processing device 52 can also communicate with one or more external devices 70 such as a keyboard, a pointing device, and/or any devices (e.g., network card, modem, etc.) that enable the processing device 52 to communicate with one or more other computing devices. In addition, the processing device 52 can communicate with one or more devices such as the cameras 20 and the radar assemblies 22. The processing device 52 can also communicate with other devices that may be used in conjunction with the methods described herein, such as a Global Positioning System (GPS) device 72 and vehicle control devices or systems 74 (e.g., for driver assist and/or autonomous vehicle control). Communication with various devices can occur via Input/Output (I/O) interfaces 76 and 78.

The processing device 52 may also communicate with one or more networks 80 such as a local area network (LAN), a general wide area network (WAN), and/or a public network (e.g., the Internet) via a network adapter 82. For example, the network 80 is a V2X network through which the computer system 50 can communicate with various vehicles and objects.

It should be understood that although not shown, other hardware and/or software components could be used in conjunction with the computer system 50. Examples include, but are not limited to: microcodes, device drivers, redundant processing units, external disk drive arrays, RAID systems, and data archival storage systems, etc.

An embodiment of a processing device or system (e.g., the on-board processor 42 and/or the computer system 50) is configured to acquire data relating to features of an environment around the vehicle 10. The vehicle environment includes various features of a surrounding area, such as roads, traffic control features, structures, other vehicles, pedestrians and/or other objects. Data relating to the environment may also be acquired from map data (e.g., a map service), other vehicles and objects (e.g., roadside units, mobile devices held by pedestrians, etc.) and/or any other suitable source of information.

Based on the acquired data, the processing device determines whether a condition exists that would prompt or potentially prompt a behavior, reaction or change in vehicle operation. If such a condition exists, the processing device performs an action, which may include generating and presenting an alert to a user, transmitting an alert message and/or controlling vehicle operation. The alert or alert message may include additional information, such as a description or representation of the condition. In an embodiment, the action is triggered based on a machine learning or artificial intelligence model configured to correlate a condition with the generation and/or transmission of an alert or other action.

As noted above, the vehicle 10 may be part of a V2X network, which may include any number of objects and/or vehicles as nodes in the network, and is not limited to any specific configuration or any specific number or type of object. Communications over a V2X network are governed by one or more communication protocols. For example, communication over a V2X network may be defined by the 3rd Generation Partnership Project (3GPP) as having four types of communication: Vehicle-to-vehicle (V2V), Vehicle-to-infrastructure (V2I), Vehicle-to-network (V2N), and Vehicle-to-pedestrian (V2P). V2V and V2P communication are typically based on broadcast transmissions between vehicles or between vehicles and vulnerable road users (VRUs, e.g., pedestrians and cyclists). V2I communication is typically performed between a vehicle and a roadside unit installed as part of an infrastructure, which may be used as a traffic control device or as a forwarding node (e.g., repeater) that extends the range of V2X communications. V2N communication is typically performed between a vehicle and a V2X application server, such as a server in a 4G/5G network, for traffic operations.

A communication device in a V2X-enabled vehicle may implement Dedicated Short-Range Communications (DSRC) communications. DSRC is a family of standards designed to support V2X communications, and may also be referred to as WAVE and is defined in the Institute of Electrical and Electronics Engineers (IEEE) standards 1609 and 802.11p. However, implementations disclosed herein are not limited to DSRC/WAVE, and may utilize other communications protocols.

A V2X-enabled vehicle may be configured to transmit and receive messages in various formats as defined by V2X communication protocols. As described herein, a message transmitted by a vehicle may include a message having a format as prescribed by a V2X protocol, but is not so limited and may have any suitable format.

For example, the vehicle 10 can transmit messages known as Cooperative Awareness Messages (CAM) or Basic Safety Messages (BSM), and Decentralised Environmental Notification Messages (DENM). Roadside infrastructure related messages include Signal Phase and Timing messages (SPAT), In Vehicle Information messages (IVI), and Service Request Messages (SRM).

A BSM is a representative message type of V2V communication, which includes information such as vehicle size, position, heading, acceleration, and brake system status. In addition, a BSM may include information such as vehicle type, description, and identification. Other types of messages include Traveler Information Messages (TIM) used to convey information regarding different traffic conditions, and MAP messages for providing geometric data on intersections and roadway lanes. SPAT messages are used to provide signal and phase-timing data for intersections, and may be linked to MAP messages to convey road details. The vehicle 10 may use any of the above message formats to provide alerts to network objects.

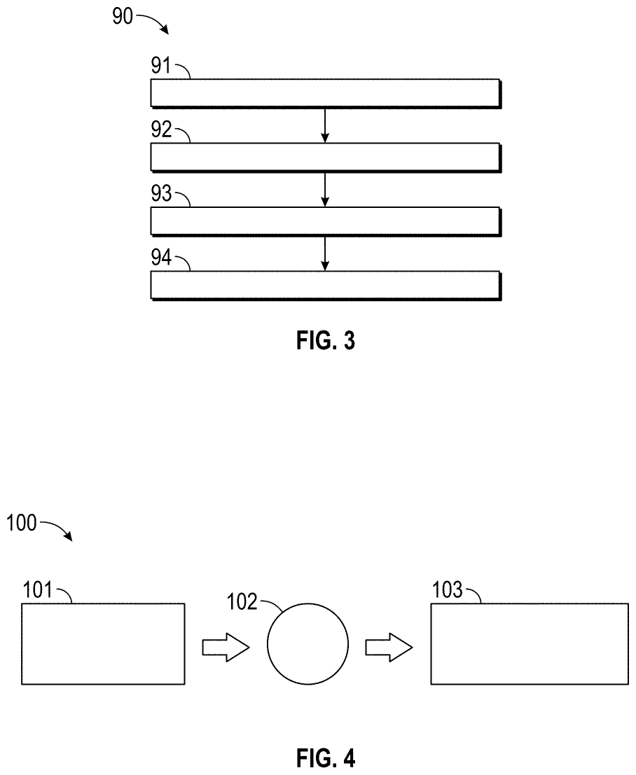

FIGS. 3-5 depict aspects of embodiments of methods of communicating with objects in a network, training and utilizing models, and/or controlling operation of a vehicle. The methods are discussed in conjunction with the vehicle 10 of FIG. 1 and a processing device, which may be (or included in), for example, the computer system 50, the on-board processor 42, a vehicle control unit, a mobile device, or a combination thereof. It is noted that the methods are not so limited and may be performed by any suitable processing device or system, or combination of processing devices or systems.

FIG. 3 illustrates an embodiment of a method 90 of communicating with objects in a network and/or controlling operation of a vehicle. The method 90 is discussed in conjunction with blocks 91-94. The method 90 is not limited to the number or order of steps therein, as some steps represented by blocks 91-94 may be performed in a different order than that described below, or fewer than all of the steps may be performed.

At block 91, the processing device acquires sensor data and estimates one or more conditions of the vehicle environment. The sensor data may be used to detect features and objects around the vehicle 10, features of a road, road condition, traffic flow and/or others. In addition, the processing device can receive information from other sources used to determine conditions, such as map data, communications from other vehicle and objects, information in a database and others.

Based on the above information, one or more conditions are identified or determined. Examples of conditions include road conditions such as curvature, width, lane size, road surface and others. Conditions may also relate to objects in the environment, such as the location and/or proximity of other vehicles. For example, conditions can include traffic flow, traffic volume, speed limit, population and/or object density (e.g., crowded area) and area type (e.g., urban, rural, residential, etc.). Conditions may include vehicle dynamics such as speed and heading, and may also include user information such as user attentiveness. A “condition” may include any of the above individual conditions or a combination of multiple conditions.

As an example, the vehicle 10 determines based on sensor data the curvature and width of a segment or length of a road around the vehicle 10, and also detects the presence of other vehicles (via the sensor data and/or based on information from other vehicles) as well as the distance between the vehicle 10 and other vehicles. The vehicle 10 also determines the road type (e.g., local, highway, dirt road, etc.) and speed limit of the road. This information, as well as optionally additional information such as map data, is used to determine the overall condition.

At block 92, one or more conditions are input to a machine learning model. The machine learning model may be any of various types and generated and/or updated using one or more machine learning algorithms. Examples of such algorithms include deep learning, supervised learning, unsupervised learning, semi-supervised learning, multi-task learning and others. Examples of machine learning models include classifiers, neural networks, regression models and others. In one example, the machine learning model is a deep neural network (DNN) such as a long short term memory (LSTM) network model.

The model determines, based on the condition, whether an alert should be generated and/or other whether other action should be performed. A condition can be associated with one or more respective parameters by which the V2X network typically determines whether an alert should be generated. If a parameter (referred to herein as an alert parameter) corresponds to a given condition, then an alert is generated if a value of the parameter matches a reference parameter value. A parameter “matches” a reference value if the parameter is within a selected range of values, exceeds a threshold, falls below a threshold or otherwise meets criteria established by the reference value. In an embodiment, the vehicle's V2X application prescribes a set of predetermined or pre-selected reference parameter values. For example, the V2X application prescribes a reference value for vehicle speed (e.g., for a condition such as high traffic density), such that if the vehicle speed matches (e.g., meets or exceeds) the reference value, an alert is generated.

In an embodiment, the model is configured to correlate each condition with an alert parameter (or parameters), and also correlate each condition with a reference value of the parameter as determined by the model. If the modeled reference parameter is different than the pre-selected reference parameter, then the model adjusts the pre-selected reference parameter accordingly. A “reference parameter value” may be a single value, a threshold, a desired range or any other value. Thus, the parameter level at which an alert is prompted is variable and adapted to specific conditions.

For example, if the alert parameter is vehicle speed, the speed level at which an alert is generated (or action is taken) may be different for road segments having different curvatures, or different for road segments having different widths. In addition, the speed level may be different for a road segment as traffic density changes. The speed level at which an alert should be generated is dynamically adjusted via the model as conditions arise or change.

At block 93, the processing device receives an output from the model, which indicates whether or not an alert should be generated. If the output indicates that an alert should be generated, the vehicle 10 generates an alert in the form of a notification to a user and/or as a message transmitted to other vehicles and objects. The message may use any of the formats discussed above and may utilize pre-configured messages, such as forward collision warning (FCW), blind spot warning and any other suitable message.

At block 94, in addition to generating an alert (or in place of generating an alert), one or more actions can be taken. For example, operation of the vehicle can be controlled to perform an evasive maneuver or limit vehicle speed.

Methods may also include training the model using training data in the form of collected road conditions and/or area conditions. The training data, in an embodiment, includes parameters used by the network (e.g., via a safety application or V2X application) to prompt the generation or transmission of an alert. For example, the parameters may be those used by the V2X network to trigger an alert to a user and/or to another object in the V2X network.

FIG. 4 illustrates a method 100 of training a machine learning model. The method 100 is discussed in conjunction with blocks 101-103, but is not limited to the number or order of steps therein.

At block 101, training data is collected, which includes data relating to sensed objects and conditions, previously existing data collected from other vehicles, and/or other information describing various conditions. The data may include various conditions and associated alert parameters. For example, the training data includes alert parameters (e.g., V2X parameters) and values of the parameters used under the conditions represented by the training data.

At block 102, the training data is applied to the model, and the model learns desired or optimal reference values of alert parameters (i.e., value(s) of the parameters that trigger an alert). At block 103, the model outputs the conditions and associated optimized parameters. The model outputs may be stored at any suitable location and in any suitable data structure, such as a lookup table (LUT).

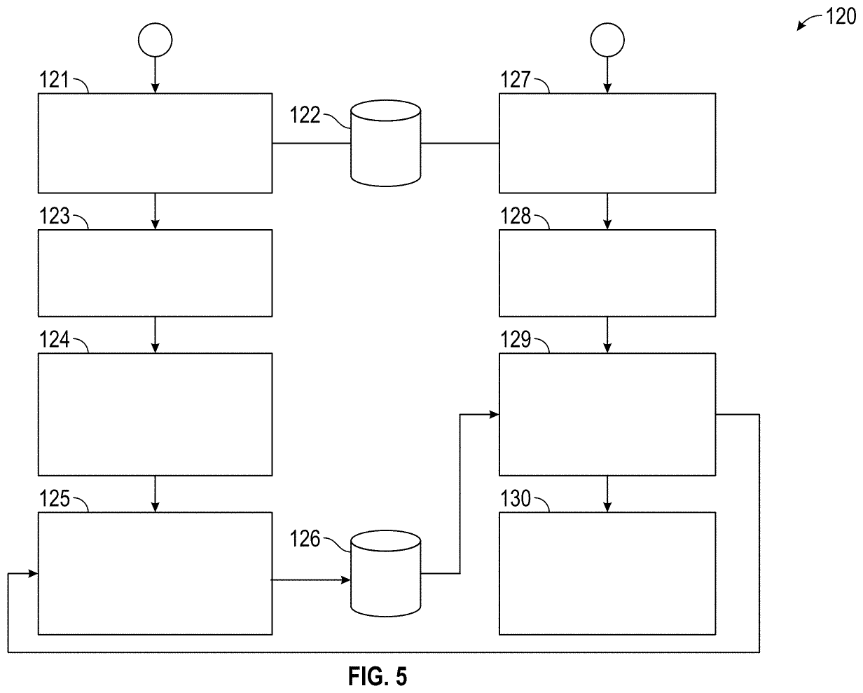

FIG. 5 is a block diagram depicting an embodiment of a method 120 of training a machine learning model and dynamically generating alerts or messages in a V2X network. The method 120 is discussed in conjunction with blocks 121-130. The method 120 is not limited to the number or order of steps therein, as some steps represented by blocks 121-130 may be performed in a different order than that described below, or fewer than all of the steps may be performed.

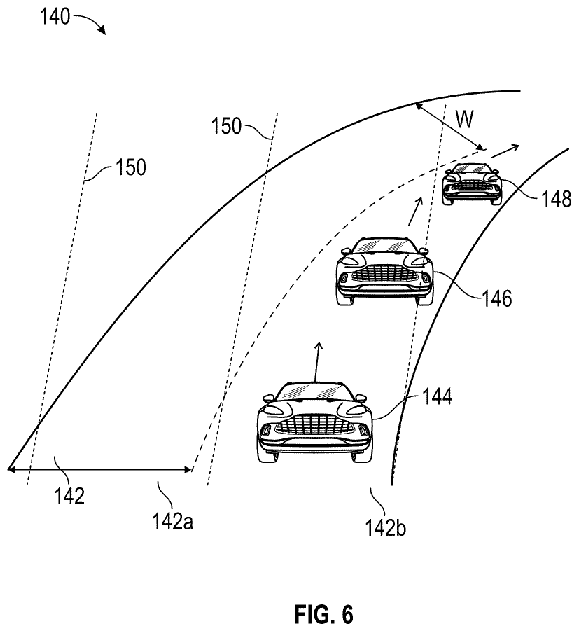

The method 120 is discussed in conjunction with an example of a scenario or condition for which an alert may be generated, as shown in FIG. 6. This scenario is provided for illustration purposes and is not intended to be limiting.

In the scenario of FIG. 6, an area 140 is shown that includes a road segment 142 including lanes 142a and 142b, and a plurality of vehicles travelling thereon. The vehicles include an ego vehicle 144, and vehicles 146 and 148 travelling ahead of the ego vehicle 144. The road segment 142 has a curvature, and lane 142a and/or 142b has a variable width that narrows along the direction of travel (as denoted by arrows extending from each vehicle).

In a typical V2X system, the ego vehicle 144 considers the heading and trajectory of the ego vehicle 144 and other vehicles such as the vehicle 146, but does not consider road curvature or variations in road curvature or width. As a result, the ego vehicle 144 assumes that the road lanes have a constant width and monitors a straight trajectory ahead, denoted by lines 150. In such a system, no warning will be triggered even if the curvature of the road is known, as the lead vehicle 148 is not considered to be in the same lane as the ego vehicle 144. In contrast, the method 120 accounts for the curvature and can optimize the V2X parameter or parameters associated with a condition or conditions related to this scenario.

The method 120 includes two phases. A training phase is represented by blocks 121-126, and an execution phase is represented by blocks 127-130. The method 120 may include both phases or one of the phases. The training phase is described as being performed by a processing device at any suitable location, whether in the vehicle 144 or elsewhere. The execution phase is described as being performed by a vehicle processor.

At block 121, during the training phase, training data indicative of road features and other aspects of an environment is collected, such as road curvature, width variant, traffic information, area information, the presence of objects and vulnerable road users, map information and/or other information. Optionally, at block 122, the processing device may input features to an existing map application, for example, as a new map or as a new layer on an existing map.

At block 123, training data indicative of the distribution of traffic flow related to the road conditions is acquired, for example, from a map application, sensors in a vehicle and/or information from other vehicles. The traffic flow distribution includes for example the distance between vehicles, the lane of each vehicle and the heading of each vehicle. The combination of road features and traffic flow distribution may be considered a “condition” that is correlated with an alert parameter (e.g., the speed of an ego vehicle and/or the proximity to other vehicles).

At block 124, for a given condition, the processing device fine tunes the alert parameter so that the reference value of the alert parameter is customized or optimized to the condition provided by the training data. The processing device determines based on the condition whether an alert should be issued. For example, if the parameter is vehicle speed, the reference value (i.e., reference speed) is selected as a range of speeds or a threshold speed.

For example, if a road segment is in a crowded area, the threshold value of vehicle speed is tuned to a lower value (as compared to a default reference value prescribed by a V2X network) to trigger a warning at lower speeds.

At block 125, training data including each condition and its associated reference parameter value is input to a machine learning model, such as a deep neural network (DNN) and LSTM network. The model is trained, for example, via an adaptive regression of parameter values. At block 126, the model may be stored locally or remotely (e.g., in a model database).

At block 127, the execution phase commences during operation of the vehicle 144. For example, sensor data from the ego vehicle 144 and/or other local information (e.g., information transmitted from the other vehicles 146 and 148) is acquired and compared with an existing map.

At block 128, condition information is extracted from the acquired data and information for the current driving situation. For example, road features including road curvature, lane information and road width are determined. The curvature and width ahead of the ego vehicle 144 may be acquired from road information transmitted from the vehicles 146 and 148. In addition, traffic flow information for the current situation is acquired.

At block 129, the model is accessed (e.g., retrieved from a database) and the current condition is input to the model. If the current condition matches a condition already evaluated by the model, the adjusted or optimized reference value for the parameter (e.g., speed) is retrieved. Failure cases (conditions that were not previously encountered by the model) may be fed back to the model as training data for further learning.

At block 130, the optimized reference value is compared to the current parameter value (e.g., vehicle speed). If the current speed matches the optimized reference value (e.g., is greater than or equal to the reference value), an alert is triggered. The alert may be provided to the user as a notification or warning (e.g., FCW) and/or transmitted or broadcast to other objects in the network as a message having a format, such as a V2X message format described herein.

While the above disclosure has been described with reference to exemplary embodiments, it will be understood by those skilled in the art that various changes may be made and equivalents may be substituted for elements thereof without departing from its scope. In addition, many modifications may be made to adapt a particular situation or material to the teachings of the disclosure without departing from the essential scope thereof. Therefore, it is intended that the present disclosure not be limited to the particular embodiments disclosed, but will include all embodiments falling within the scope thereof

What is claimed is:

1. A method of controlling operation of a vehicle, comprising:
monitoring one or more features of a road segment, the vehicle configured to communicate with a plurality of objects in a wireless communication network, the vehicle configured to generate a communication based on a reference value of a parameter related to at least one of an environment around the vehicle and a behavior of the vehicle;
determining, based on the monitoring, a condition of the road segment, the condition including at least a curvature of the road segment;
inputting the condition into a machine learning model, the machine learning model configured to adjust the reference value of the parameter based on the condition and output an adjusted reference value; and
comparing the adjusted reference value to a current parameter value, and based on the adjusted reference value matching the current parameter value, transmitting an alert to one or more of the plurality of objects.

2. The method of claim 1, wherein the condition includes a variation in width of at least one of the road segment and a road lane.

3. The method of claim 1, wherein the machine learning model includes a neural network.

4. The method of claim 1, wherein determining the condition includes acquiring sensor data from at least one other vehicle ahead of the vehicle.

5. The method of claim 4, wherein determining the condition includes estimating the curvature based on the acquired sensor data.

6. The method of claim 4, wherein the condition includes an estimation of traffic flow based at least on the acquired sensor data.

7. The method of claim 1, wherein the wireless communication network is at least one of a vehicle-to-vehicle (V2V) and a vehicle-to-everything (V2X) network.

8. The method of claim 7, wherein the reference value of the parameter is a predetermined reference value selected based on a communication protocol of the wireless communication network.

9. A system for controlling operation of a vehicle, comprising:
a monitoring unit configured to monitor one or more features of a road segment, the vehicle configured to communicate with a plurality of objects in a wireless communication network, the vehicle configured to generate a communication based on a reference value of a parameter related to at least one of an environment around the vehicle and a behavior of the vehicle, the monitoring unit configured to determine, based on the monitoring, a condition of the road segment, the condition including at least a curvature of the road segment;
an adjustment unit configured to input the condition to a machine learning model, the machine learning model configured to adjust the reference value of the parameter based on the condition and output an adjusted reference value; and
a processing unit configured to compare the adjusted reference value to a current parameter value, and based on the adjusted reference value matching the current parameter value, transmit an alert to one or more of the plurality of objects.

10. The system of claim 9, wherein the condition includes a variation in width of at least one of the road segment and a road lane.

11. The system of claim 9, wherein the machine learning model includes a neural network.

12. The system of claim 9, wherein determining the condition includes acquiring sensor data from at least one other vehicle ahead of the vehicle.

13. The system of claim 12, wherein determining the condition includes estimating the curvature based on the acquired sensor data.

14. The system of claim 12, wherein the condition includes an estimation of traffic flow based at least on the acquired sensor data.

15. The system of claim 9, wherein the wireless communication network is at least one of a vehicle-to-vehicle (V2V) and a vehicle-to-everything (V2X) network.

16. The system of claim 15, wherein the reference value of the parameter is a predetermined reference value selected based on a communication protocol of the wireless communication network.

17. A vehicle system comprising:
a memory having computer readable instructions; and
a processing device for executing the computer readable instructions, the computer readable instructions controlling the processing device to perform a method including:
monitoring one or more features of a road segment, the vehicle configured to communicate with a plurality of objects in a wireless communication network, the vehicle configured to generate a communication based on a reference value of a parameter related to at least one of an environment around the vehicle and a behavior of the vehicle;
determining, based on the monitoring, a condition of the road segment, the condition including at least a curvature of the road segment;
inputting the condition into a machine learning model, the machine learning model configured to adjust the reference value of the parameter based on the condition and output an adjusted reference value; and
comparing the adjusted reference value to a current parameter value, and based on the adjusted reference value matching the current parameter value, transmitting an alert to one or more of the plurality of objects.

18. The vehicle system of claim 17, wherein the condition t includes a variation in width of at least one of the road segment and a road lane.

19. The vehicle system of claim 17, wherein the machine learning model includes a neural network.

20. The vehicle system of claim 17, wherein the wireless communication network is at least one of a vehicle-to-vehicle (V2V) and a vehicle-to-everything (V2X) network, and the reference value of the parameter is a predetermined reference value selected based on a communication protocol of the wireless communication network.
